(19) United States
(12) Patent Application Publication
(10) Pub. No.: US 2006/0038787 A1
(43) Pub. Date: Feb. 23, 2006

(54) Processing system and method for detecting hotkey activation

(76) Inventor: Jia-Shiung Kuo, Taipei (TW)

Correspondence Address: EDWARDS & ANGELL, LLP, P.O. BOX 55874, BOSTON, MA, 02205, US

(21) Appl. No.: 10/921,403

(22) Filed: Aug. 18, 2004

(51) Int. Cl. G09G 5/00

(52) U.S. Cl. 345/168

(57) ABSTRACT

A processing system and method for detecting hotkey activation allows a computer device to determine whether a keyboard hotkey is activated by a user and to execute a corresponding application program associated with the hotkey if being activated. The system and method respectively associate each bit in a first register and a second register with each hotkey. Altering a value of the bit in the first register allows the computer device to identify if the hotkey is being pressed, and altering a value of the bit in the second register allows the computer device to identify if the hotkey has been released. The computer device thus detects the operating status of the hotkey in a polling manner via the first and second registers, thereby providing an active processing way for detecting hotkey activation to maintain the stability of the computer device.

### FIELD OF THE INVENTION

The present invention relates to processing systems and methods for detecting hotkey activation, and more particularly, to a processing system and method for detecting hotkey activation applied to a keyboard of a computer system.

### BACGROUND OF THE INVENTION

When activating an application program in a computer, the user usually has to enter hierarchically into the directory where the application program is located and executes the application program to be executed, or select the “Start” function of a functional menu provided by the computer operating system on the computer and clicks the desired option under a “Program Files” listing to initiate execution of the program to be executable. Therefore, in order to save the user's time, software or computer manufacturers add the function of hotkeys and shortcuts to the computer to provide the user with a way to activate application programs faster.

To provide the hotkey functionality described above, one of two methods is usually used: one method is to generate a scan code from a Keyboard Controller (abbreviated as KBC) to provide pre-programmed application software (i.e. a keyboard driven program) executes hotkey functions associated with the scan code generated; the other method is to control the Serial Control Interface (abbreviated as SCI) to generate a control signal for processing hotkeys via the program code of the Advanced Configuration and Power Interface Source Language (abbreviated as ASL).

In general, the application software as described above is additionally installed to an operating system, such as Windows, to provide hotkey functionality. According to the scan code generated by the KBC, the subject application program determines whether the pre-set hotkey has been activated. If it is determined that a hotkey has been activated, then a System Management Interrupt (abbreviated as SMI) signal is output, and, the current activated hotkey is obtained according to the System Management Interrupt signal.

However, the method to determine whether a hotkey has been activated as described above, the KBC needs to generate the scan codes, such that whether the user has pressed a hotkey and which hotkey is pressed can be determined according to the scanned result of the scan codes, before notifying the computer device. This kind of passive method easily renders the computer system unsteady. Therefore, an important problem currently needing to be solved is how to maintain computer stability while still detecting hotkeys activation.

### SUMMARY OF THE INVENTION

In light of the above drawbacks in the prior art, a primary objective of the present invention is to provide a processing system and method for detecting hotkeys activation without using scan codes, such that unstable operation of the computer system can be avoided.

In accordance with the foregoing and other objectives, the present invention provides a processing system and method for detecting hotkeys activation that provide a computer device with a way to determine whether the user has activated a hotkey of the keyboard, and initiate the program installed on the computer device associated with the hotkey. The processing system for detecting hotkey activation at least comprises: a controller, a processor, a first register, and a second register. The controller electrically connected with a keyboard, used to detect the keying signal entered by the user from the keyboard. The processor, electrically connected with the controller that, in accordance with the keying signal detected by the controller, executes the corresponding process. The first register is formed of several bits, each bit corresponding respectively with a hotkey of the keyboard, and the second register is formed of several bits, each bit corresponding respectively with each hotkey of the keyboard. Once the controller detects hotkey activation of the keyboard, the corresponding bits for the hotkey in the first and the second registers are set, such that when a hotkey activation program detects that the bit has been set in the first register by polling, the processor executes the corresponding application program for that hotkey, and then, when the controller detects that the hotkey of the keyboard has been released and the set-value of the corresponding bits for the hotkey in the second register is changed immediately, enabling the hotkey activation program to know it has been released by polling.

The method for detecting hotkey activation at least comprises the steps of: pre-setting a first register in a computer device, wherein this first register is formed of several bits, each bit corresponding respectively with each individual hotkey of the keyboard; pre-setting a second register in the computer device, wherein the second register is formed of several bits, each bit corresponding respectively with each individual hotkey of the keyboard; the computer device detecting hotkey activation of the keyboard that the user presses, and then setting the set-value for the corresponding bits for the hotkey in the first and the second registers, allowing the computer device to identify which hotkey has been pressed; the computer device executing the application program corresponding to that hotkey, and altering the set-value of the corresponding bit for the hotkey in the first register; and, the computer device detecting when the hotkey of the keyboard has been released by the user, then setting the set-value of the corresponding bit for the hotkey in the second register, allowing the computer device to identify that the hotkey has been released.

The processing system and method for detecting hotkey activation of the present invention establish corresponding bits in the first and the second register for every hotkey, permitting the computer device to identify whether a hotkey of the keyboard has been pressed by referring to the alteration of the value of the corresponding bit in the first register; allowing recognition of when the hotkey has been released by referring to the alteration of the value of the corresponding bit in the second register. Therefore, it enables the computer device by use of the first and the second registers to determine actively whether a hotkey of the keyboard has been pressed or released, making use of a scan code unnecessary. Thus, it efficiently avoids the possibility of erroneous judgment when a hotkey is pressed or released during the process of generating and transmitting the scan code to the computer device, which causes unstable operation of the computer device. In other words, utilizing the first and the second registers in the processing system and method for detecting hotkey activation of the present invention enables the computer device to determine actively and accurately the status of a hotkey being pressed and released.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing basic structure of a processing system for detecting hotkey activation according to the present invention; and

FIG. 2 is a flow chart showing procedural steps of a processing method for detecting hotkey activation according to the present invention.

### DETAILED DESCRIPTION OF THE PREFERRED EMBODIMENTS

Specific embodiment of the present invention will be described by way of example below, where those skilled in the art would easily understand the advantage and functions of the present invention through reading the content disclosed herein. This present invention can be implemented and applied through other different embodiments. Various details disclosed in the this specification can be modified and changed, based on different considerations and applications, while still falling under the scope and spirit of the present invention.

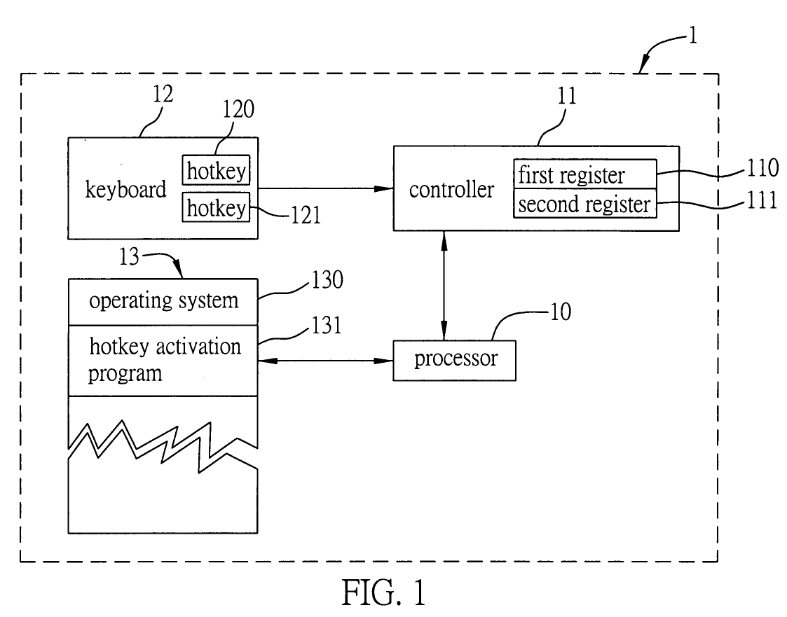

FIG. 1 shows a basic structure diagram of the processing system to detect hotkey activation of the present invention. As shown, the processing system 1 for detecting hotkey activation of the present invention can be applied to a computer device (not shown), for example, a notebook or desktop personal computer, etc. The processing system 1 is used to provide the computer device with a way to determine whether the user has pressed a hotkey of the keyboard, and enable the computer device to execute the application program corresponding to the hotkey function. The processing system 1 for detecting hotkey activation comprises at least a processor 10, a controller 11 containing at least one first register 110 and one second register 111, a keyboard 12 with a plurality of hotkeys (120, 121), and a memory unit 13 used to store at least one operating system 130 and a hotkey activation program 131 associated with the hotkeys (120, 121). In order to simplify the diagram and explanation, here, the system structure only displays the system components which relate to the present invention, other system components being omitted from the diagram, such as mouse, monitor, southbridge chip, northbridge chip or BIOS ROM, etc.

The processor 10 is the central processing unit of processing system 1 for detecting hotkey activation, used to control, analyze and process those components electrically connected thereto, to provide the required process for user. The processor 10 enables the processing system 1 for detecting hotkey activation to execute the general boot process of the computer device, according to the operating system 130 stored (e.g. Windows operating system) in the memory unit 13. Furthermore, the processor 10 enables the processing system 1 for detecting hotkey activation to determine whether the user has pressed a hotkey (120, 121) on the keyboard 12, and quickly begin execution of the application program (not shown) corresponding to the hotkey (120, 121), according to the hotkey activation program 131 stored in the memory unit 13. The technique used to associate a hotkey with an application program is a well-known setup procedure and will not be described herein.

The controller 11, such as the keyboard controller (abbreviated as KBC), is used to determine whether the user presses a particular keystroke on the keyboard 12. The first register 110 and the second register 111 is built in the controller 11, both registers (110, 111) consist of a plurality of bits respectively, wherein each bit of the first register 110 corresponds to a hotkey of the keyboard 12 respectively. When the controller 11 detects that one of the hotkeys (120 or 121) of the keyboard 12 has been activated, then it sets the corresponding bit for that hotkey (120 or 121) in the first register 110 and also instructs the processing system 1 for detecting hotkey activation to execute the corresponding application program (not shown) for the hotkey (120 or 121).

The following example illustrates a possible scenario for the first register 110 with 8 bits:

| | | | | | | | |
|---|---|---|---|---|---|---|---|
| Bit 7 | Bit 6 | Bit 5 | Bit 4 | Bit 3 | Bit 2 | Bit 1 | Bit 0 |

Bit 0: used to allow the controller 11 to determine whether the hotkey 120 has been pressed.
Bit 1: used to allow the controller 11 to determine whether the hotkey 121 has been pressed.
Bit 2 to Bit 7: unused in the current example.

Bit 2 to Bit 7 could be used for determining whether other hotkeys have been pressed; however, this present embodiment only utilizes hotkey 120 and hotkey 121. When a value “1” is stored in a bit of the first register 110, it indicates the hotkey corresponding to the bit has been pressed, and a value “0” indicates the hotkey corresponding to the bit has not been pressed.

Each bit of the second register 111 also corresponds respectively with a hotkey of the keyboard 12, which allows the controller 11 to detect whether a hotkey (120 or 121) on the keyboard 12 has been pressed or released. When a hotkey is pressed, in addition to setting the corresponding bit for the hotkey (120 or 121) in the above described first register 110, the corresponding bit for the hotkey (120 or 121) in the second register 111 is also set. Furthermore, when the user releases the hotkey (120 or 121), the bit corresponding to the hotkey (120 or 121) in the second register 111 is also set. The following example illustrates a possible scenario for the second register 111 with 8 bits:

| | | | | | | | |
|---|---|---|---|---|---|---|---|
| Bit 7 | Bit 6 | Bit 5 | Bit 4 | Bit 3 | Bit 2 | Bit 1 | Bit 0 |

Bit 0: used to allow the controller 11 to determine whether the hotkey 120 has been pressed.
Bit 1: used to allow the controller 11 to determine whether the hotkey 121 has been pressed.
Bit 2 to Bit 7: unused in the current example.

Bit 2 to Bit 7 could be used for determining whether other hotkeys have been pressed; however, this present embodiment only utilizes hotkey 120 and hotkey 121. A value “1” stored in a bit of the second register 111 means the hotkey corresponding to the bit has not been released. Consequently, a value “0” means the hotkey corresponding to the bit has been released.

The hotkey activation program 131 stored in the memory unit 13 is executed upon the system boots. The hotkey program 131 detects the alteration status of the corresponding bit stored in the first register 110 and the second register 111 by way of polling, to enable the processor 10 to automatically determine whether the user presses the hotkey and which key is pressed, depending on the value of a corresponding bit in the first register 110 and the second register 111. In other words, the values stored in the bits of the first register 110 and the second register 111 can be considered as flags. By providing values “0” or “1” from the flags, the processor 10 easily and automatically obtains the hotkey status determined by the controller 11, wherein there are four kinds of hotkey status: pressed, not pressed, released and not released. This method uses registers instead of scan codes generated by the controller 11 to determine whether the hotkey has been pressed. Therefore, the processing system for detecting hotkey activation of the present invention provides an active processing method for detecting hotkey activation, thereby improves the stability of the computer system.

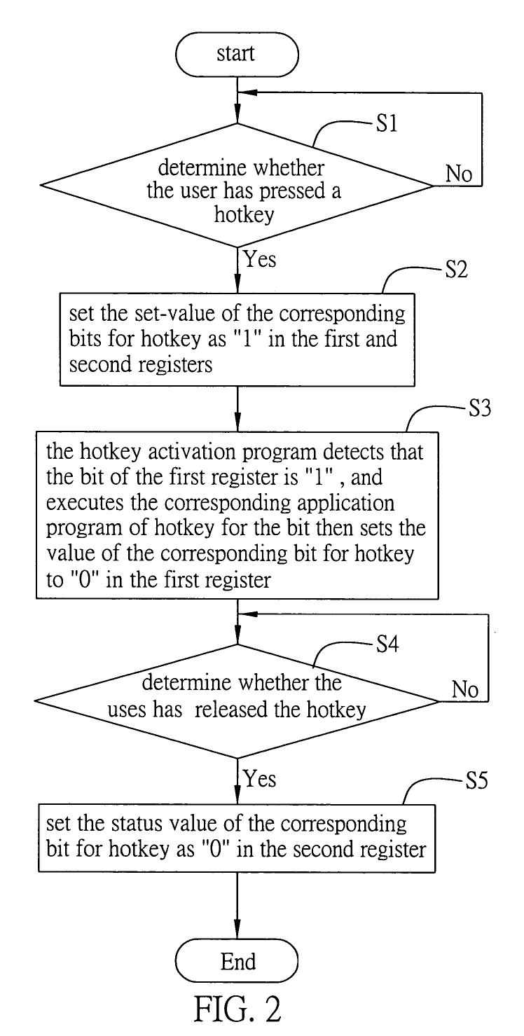

FIG. 2 shows an operation flow of the processing method for detecting hotkey activation of the present invention. After initiating the processing system 1 for hotkey activation detection through the operating system 130 of the memory unit 131, the operating system 130 loads the hotkey activation program 131. Then the controller 11 determines whether the values stored in the bits in the first register 110 and the second register 111 have been changed according to polling by the hotkey activation program 131.

As the diagram shows, starting with Step S1, the controller 11 determines whether the user has pressed a hotkey (120 or 121) of the keyboard 12, if the hotkey has been pressed, then go to Step S2; if not, then continue with Step S1.

In Step S2, the controller 11 sets the bit values in the first register 110 and the second register 111 corresponding to the pressed hotkey as “1”, then go to Step S3.

In Step S3, upon the hotkey activation program 131 detecting the bit value in the first register 110 as “1”, the hotkey application program corresponding to the bit is executed and the value of the bit corresponding to the hotkey in the first register 110 is set to “0”, then go to Step S4.

In Step S4, the controller 11 determines whether the user releases the hotkey (120 or 121) of keyboard 12, if the hotkey has been released, then go to Step S5; if not, then continue with Step S4.

In Step S5, the controller 11 sets the value of the bit corresponding to the released hotkey in the second register 111 to “0”.

From the above, it can be seen that the processing system and method for detecting hotkey activation of the present invention sets up a flag for every hotkey respectively, which is used to indicate whether corresponding hotkeys have been pressed and released. It enables the hotkey activation program uses the polling method to automatically detect the usage status of the hotkey. Therefore, it efficiently solves the problem of system instability in conventional method of determining hotkey activation utilizing scan codes generated by the keyboard controller to trigger the hotkey activation program.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A processing system for detecting hotkey activation, for allowing a computer device to determine whether a hotkey of a keyboard is activated by a user so as to initiate a hotkey activation program in the computer device to execute an application program corresponding to the hotkey if being activated, the processing system for detecting hotkey activation comprising:
a controller electrically connected to the keyboard and for detecting a keying signal generated corresponding to the hotkey of the keyboard being activated by the user;
a processor electrically connected to the controller and for executing a corresponding process according to the keying signal detected by the controller;
a first register comprising a plurality of bits, each of the bits corresponding to each hotkey provided by the keyboard respectively; and
a second register comprising a plurality of bits, each of the bits corresponding to each hotkey provided by the keyboard respectively,
wherein when the controller detects activation of the hotkey of the keyboard, the controller sets the bits, which correspond to the hotkey, in the first and second registers, to allow the hotkey activation program to detect via polling the corresponding bit of the first register being set, and allow the processor to execute the application program corresponding to the hotkey, and wherein when the controller detects the hotkey being released, the controller alters a value of the corresponding bit of the second register being set, to allow the hotkey activation program to detect via polling that the hotkey has been released.

2. The processing system for detecting hotkey activation of claim 1, wherein the controller is a keyboard controller.

3. The processing system for detecting hotkey activation of claim 1, wherein the processor is a microprocessor.

4. The processing system for detecting hotkey activation of claim 1, wherein the bit of the first register storing a value of “0” indicates that the hotkey corresponding to the bit is not being pressed, and the bit of the first register storing a value of “1” indicates that the hotkey corresponding to the bit is being pressed.

5. The processing system for detecting hotkey activation of claim 1, wherein the bit of the second register storing a value of “1” indicates that the hotkey corresponding to the bit has not been released, and the bit of the second register storing a value of “0” indicates that the hotkey corresponding to the bit has been released.

6. A processing method for detecting hotkey activation, for allowing a computer device to determine whether a hotkey of a keyboard is activated by a user and to execute an application program corresponding to the hotkey if being activated, the processing method for determining the hotkey activation comprising the steps of:
pre-setting a first register in the computer device, wherein the first register comprises a plurality of bits, each of the bits corresponding to each hotkey provided by the keyboard respectively;
pre-setting a second register in the computer device, wherein the second register comprises a plurality of bits, each of the bits corresponding to each hotkey provided by the keyboard respectively;
determining the hotkey of the keyboard activated by the user and setting values of bits, which correspond to the hotkey, in the first and second registers via the computer device;
executing the application program corresponding to the hotkey and altering the value of the bit in the first register that corresponds to the hotkey via the computer device; and
determining via the computer device if the hotkey of the keyboard has been released by the user and altering the value of the bit in the second register that corresponds to the hotkey if being released.

7. The processing method for detecting hotkey activation of claim 6, wherein the first and second registers are provided by a controller.

8. The processing method for detecting hotkey activation of claim 7, wherein the controller is a keyboard controller.

9. The processing method for detecting hotkey activation of claim 6, wherein the bit of the first register storing a value of “0” indicates that the hotkey corresponding to the bit is not being pressed, and the bit of the first register storing a value of “1” indicates that the hotkey corresponding to the bit is being pressed.

10. The processing method for detecting hotkey activation of claim 7, wherein the bit of the first register storing a value of “0” indicates that the hotkey corresponding to the bit is not being pressed, and the bit of the first register storing a value of “1” indicates that the hotkey corresponding to the bit is being pressed.

11. The processing method for detecting hotkey activation of claim 8, wherein the bit of the first register storing a value of “0” indicates that the hotkey corresponding to the bit is not being pressed, and the bit of the first register storing a value of “1” indicates that the hotkey corresponding to the bit is being pressed.

12. The processing method for detecting hotkey activation of claim 6, wherein the bit of the second register storing a value of “1” indicates that the hotkey corresponding to the bit has not been released, and the bit of the second register storing a value of “0” indicates that the hotkey corresponding to the bit has been released.

13. The processing method for detecting hotkey activation of claim 7, wherein the bit of the second register storing a value of “1” indicates that the hotkey corresponding to the bit has not been released, and the bit of the second register storing a value of “0” indicates that the hotkey corresponding to the bit has been released.

14. The processing method for detecting hotkey activation of claim 8, wherein the bit of the second register storing a value of “1” indicates that the hotkey corresponding to the bit has not been released, and the bit of the second register storing a value of “0” indicates that the hotkey corresponding to the bit has been released.
